(19) United States
(12) Patent Application Publication
(10) Pub. No.: US 2015/0346928 A1
(43) Pub. Date: Dec. 3, 2015

(54) PROVIDING E-BOOK CONTENT TO DEVICES USING ONE OF MULTIPLE FORMATS

(71) Applicant: Kobo Inc., Toronto (CA)

(72) Inventor: Robert MacArthur, Milton (CA)

(73) Assignee: Kobo Inc., Toronto (CA)

(21) Appl. No.: 14/287,919

(22) Filed: May 27, 2014

(51) Int. Cl. G06F 3/0483; G06F 3/0484

(52) U.S. Cl. CPC G06F 3/0483; G06F 3/04842

(57) ABSTRACT

A method and system for providing e-book content is described. A position in a content of an e-book is determined. The position can indicate when a user stopped consuming the content on a first computing device associated with the user. At least a remaining portion of the content subsequent to the position can be divided into multiple portions. A first portion of the multiple portions can be provided to a second computing device associated with the user using one of multiple formats.

### TECHNICAL FIELD

Embodiments described herein relate to an e-reader device and a service system to communicate with the e-reader device, and more specifically, to a service system that enables e-book content to be provided to multiple devices using any one of multiple formats.

### BACKGROUND

An electronic personal display is a mobile electronic device that displays information to a user. While an electronic personal display may be capable of many of the functions of a personal computer, a user can typically interact directly with an electronic personal display without the use of a keyboard. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader, is an electronic personal display that is used for reading electronic books (e-books), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for operating a computing device to enhance consumption of e-book content, according to an embodiment.

FIG. 2 illustrates an example of an e-reader device or other electronic personal display device, for use with one or more embodiments described herein.

FIG. 3 illustrates an example e-book device system for enhancing consumption of e-book content, according to an embodiment.

FIG. 4 is a block diagram that illustrates a computer system, for use with one or more embodiments described herein.

FIG. 5 illustrates an example service system to provide e-book content using one of multiple formats.

FIG. 6 illustrates an example computer-implemented method for providing e-book content using one of multiple formats, according to at least some embodiments.

### DETAILED DESCRIPTION

Examples described herein include a computing device that can enable a user to request e-book content to be provided to the user using a one of multiple different formats, and a service system to provide e-book content to the user using a user-specified format.

In examples described herein, a content item can have a predefined structure and format. By way of example, a content item can correspond to an e-book (including electronic magazines or comic books) having pagination and/or chapter designations, and a format such as Electronic Publication (“EPUB”), APABI, Hypertext Markup Language (“HTML”), iBOOK, KF8, MICROSOFT LIT, AZW, or Digital Accessible Information System (“DAISY”). In variations, the content item can correspond to a document having pagination and/or chapter designations in formats such as Portable Document Format (“PDF”) or Plain text files.

According to an example, a user can operate a computing device, such as an e-reader device, to consume (e.g., read, view) content of an e-book. The user can provide input via the e-reader device to mark a position to indicate when the user has stopped consuming the e-book content (e.g., indicate the last read sentence or text of the e-book content) and/or to request that the e-book content be delivered to the user using a different format (than the e-book viewing format on the e-reader device). A service system can communicate with the e-reader device to receive the request and to determine a position in the e-book content indicating when the user stopped consuming the e-book content. The service system can divide at least a remaining portion of the e-book content subsequent to the position into multiple portions (e.g., atomize the e-book content). The service system can provide a first portion of the multiple portions to another computing device of the user using one of multiple formats.

Still further, in one embodiment, the user can operate the other computing device to consume the first portion received from the service system via one of the multiple formats. The user can operate the other computing device to transmit, to the service system, a request to consume an additional portion (e.g., a second portion or a subsequent portion) of the e-book content. The service system can determine the subsequent portion and provide the subsequent portion to the user's other computing device using one of the multiple formats (or in another format, if specified by the user in the request). In this manner, e-book content can be atomized (e.g., divided or fragmented) into portions so that the user can consume the e-book content outside of the e-reader device (e.g., without using the e-reader device functionality).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

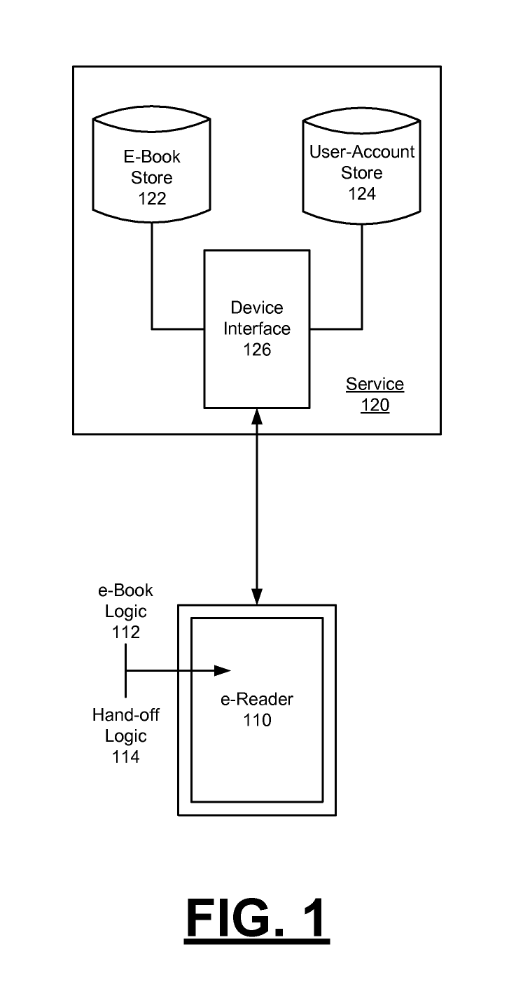

FIG. 1 illustrates a system for operating a computing device to enhance consumption of e-book content, according to an embodiment. In an example of FIG. 1, the system includes an electronic display device, shown by way of example as an e-reader device 110, and a network service 120. The e-reader device 110 can communicate with the network service 120 over one or more networks (e.g., wirelessly). The network service 120 may include multiple servers and other computing resources that provide various services in connection with one or more applications that are installed on the e-reader device 110. By way of example, in one implementation, the network service 120 provides e-book services, which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. In one example, the e-reader device 110 corresponds to a tablet or a telephony/messaging device (e.g., smart phone). For example, the e-reader device 110 can have a tablet like form factor, although variations are possible. In some cases, the e-reader device 110 can also have an E-ink display.

In one example, the e-reader device 110 also runs an e-reader application that links the respective device to the network service 120 and enables e-books provided through the service to be viewed and consumed by a user. An e-book can correspond to a publication or a document in digital form, comprising text and/or graphics, which can be displayed on the e-reader device 110. In another implementation, the e-reader device 110 can run a media playback or streaming application which receives files or streaming data from the network service 120. By way of example, the e-reader device 110 can be equipped with hardware and software to optimize certain application activities, such as rendering of electronic content (e.g., e-books). Although examples described herein refer to e-books, the e-reader device 110 can display other types of documents, such as a .pdf file, a .doc file, a .txt file, etc., and in general, can display other content items that include text content.

In additional detail, the network service 120 can include a resource store 122, a user account store 124, and a device interface 126. The resource store 122 can store a plurality of documents, such as e-books, to be accessed by the e-reader device 110 (and other e-reader devices) that are registered or subscribed with the network service 120. The user account store 124 can store information that associates the e-reader device 110 with a user and with an account. The account can also be associated with one or more application resources or content items (e.g., e-books), which can be stored in the resource store 122. The device interface 126 enables the e-reader device 110 to communicate with the network service 120.

As described further, the user account store 124 can retain metadata for individual accounts to identify resources that have been purchased or made available for consumption for a given account. The e-reader device 110 may be associated with a user account, and multiple devices may be associated with the same account. As described in greater detail below, the e-reader device 110 can store content items (e.g., e-books) that are purchased or otherwise made available to the user of that e-reader device 110, as well as to archive e-books and other digital content items that have been purchased for the user account, but are not stored on the e-reader device 110.

With further reference to FIG. 1, the e-reader device 110 can include e-book logic 112 and hand-off logic 114. The e-book logic 112 operates to enable a user of the e-reader device 110 to access, view, and/or edit a collection of digital content items belonging to a user (e.g., digital content items that the user has purchased for download, licensed, or otherwise obtained a right of possession). The e-book logic 112 can also operate to communicate with the network service 120 to browse, view, and/or purchase, license, or obtain rights to other content items. In some examples, the e-book logic 112 also operates to display graphic representations of individual content items. For example, the e-book logic 112 can display icons representing album covers, movie titles, and television shows. In the context of e-books, the e-book logic 112 displays icons representing book covers or jackets, magazine covers, comic book covers etc., corresponding to content items belonging to the user. The e-book logic 112 can provide multiple organizational structures for displaying graphic representations of content items, such as in lists, folders, or virtual structures, such as bookshelves (for e-books). The e-book logic 112 enables the user to select a content item, such as an e-book, and displays a portion of content (e.g., text, graphics) of the selected content item (e.g., display a page of the e-book in a paginated view) on a display of the e-reader device 110.

The e-reader device 110 can include hand-off logic 114, which operates to enable a user to consume (e.g., read, view, or listen to) e-book content outside of the e-book application or e-book environment. In one example, the hand-off logic 114 can provide a user interface to enable the user to (i) mark or indicate where the user left off reading the e-book content on the e-reader device 110 (e.g., a position in the e-book content in which the user stopped consuming the e-book content) and/or (ii) request that the e-book content be provided using a different format (e.g., a different format than the e-book application format). The network service 120 can respond to the request by providing, to the user, at least a portion of the e-book content subsequent to the position in the e-book content using one of multiple formats. In this manner, the portion can be made accessible to the user and can be consumed by the user using the e-reader device 110 and/or other devices operated by the user.

As an example, the user may consume e-book content on her e-reader device 110 (e.g., a novel). When the user is ready to stop reading, the user can mark or indicate on a displayed page of the e-book the last sentence or text that she has just finished reading by providing an input on the e-reader device 110. Depending on implementation, the e-book logic 112 and/or the hand-off logic 114 (in connection with the e-book logic 112) can provide a user interface to enable the user to mark the stop position in the displayed page of the e-book content. For example, the user may have just finished the last sentence of a chapter or paragraph, such as chapter ten, of the e-book, and provide a marking at the end of the last sentence on the displayed page.

The hand-off logic 114 can also provide selectable features on a user interface to enable the user to make a request, to the network service 120, to continue consuming the e-book content from the stop position using a different format (of multiple formats). For example, the hand-off logic 114 can provide the user with a plurality of format options (such as an in a drop-down menu feature) indicating the user to select how she would like to continue consuming the e-book content. Depending on variations, the different formats can include text message (e.g., short message server or SMS, or message using instant messaging), an audio file, an e-mail, or other formats in which text from the e-book content can be replicated and provided to the user. If the user selects the e-mail format option on the e-reader device 110, the hand-off logic 114 can transmit a hand-off request to the network service 120, which can include the specified format requested by the user. The network service 120 can then provide at least a portion of e-book content subsequent to the position indicated by the user (e.g., a portion of text starting at chapter eleven) via the specified format (e.g., e-mail). The user can receive the e-mail at her e-mail account, and can view the e-mail by accessing her email account from any device.

The user can access her email account on a computing device (e.g., smartphone or laptop computer, or in other examples, the e-reader device 110) and open the e-mail sent from the network service 120 using an e-mail application or a browser. The body of the e-mail message can include text from the subsequent portion of the e-book content from the position indicating when the user stopped consuming the e-book content on the e-reader device 110. In this manner, the user is able to continue consuming the e-book when she may not have a large block of time to read, as one or more portions of the e-book content are limited in size and amenable to consumption. Consumption of e-book content can be enhanced by enabling the user to continue to read an e-book using different platforms and/or on different devices outside of the e-reader device 110 environment.

Device Hardware Description

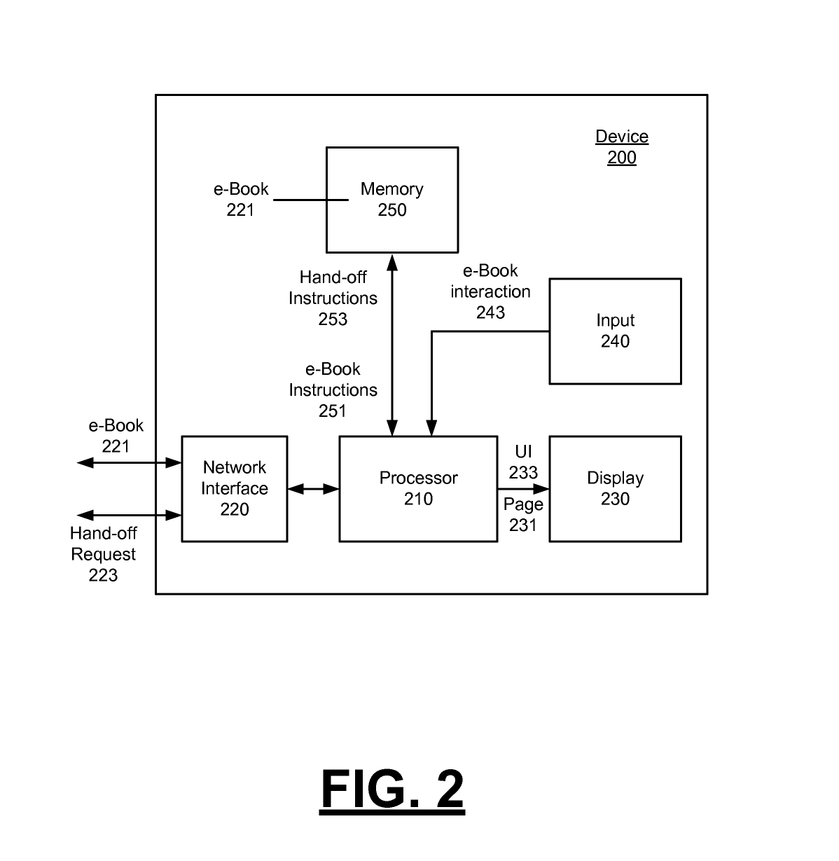

FIG. 2 illustrates an example of an e-reader device or other electronic personal display device, for use with one or more embodiments described herein. In an example of FIG. 2, an e-reader device 200 corresponds to, for example, an e-reader device 110, such as also shown by an example of FIG. 1. With reference to FIG. 2, the e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 over one or more networks. More specifically, the e-reader device 200 can access the network service 120 to receive various kinds of resources (e.g., digital content items, such as e-books, configuration files, account information), as well as to provide information (e.g., user account information, service requests, etc.). For example, the e-reader device 200 can receive content items, such as e-books 221 or media files, that the user elects to purchase and/or otherwise download from the network service 120. The content items that are downloaded onto the e-reader device 200 can be stored in the memory 250.

In some implementations, the display 230 can correspond to, for example, a liquid crystal display (LCD) or light emitting diode (LED) display that illuminates in order to provide content generated from the processor 210. In some examples, the display 230 can be touch-sensitive. In some variations, the display 230 can correspond to an electronic paper type display, which mimics conventional paper in the manner in which they display content. Examples of such display technologies include electrophoretic displays, electrowetting displays, and electrofluidic displays.

The processor 210 can receive input from various sources, including from one or more input mechanisms 240 (e.g., buttons or switches, microphone, keyboard, etc.), the display 230 (e.g., soft buttons or keyboard presented on a touch-sensitive display), or other input mechanisms (e.g., accessory devices that are connected to the e-reader device 200 via a cable or via a wireless communication medium, such as Bluetooth). The processor 210 can receive user input and based on the user input, identify a content item (e.g., e-book 221) for display and display a portion of text content of the content item on the display 230. The user can provide user input to interact with the displayed e-book 221 (e.g., change pages, make bookmarks, add notes, highlight text, etc.) to cause the e-reader device 200 to perform e-book activities.

With further reference to FIG. 2, the memory 250 can store instructions 251 for implementing e-book logic 112 (see FIG. 1) and instructions 253 for implementing hand-off logic 114 (see FIG. 1). As discussed, application resources, such as content items (e.g., e-books 221), can be received by the network interface 220 from, for example, the network service 120 and stored in the memory 250. Each e-book 221 can include a metadata set and content portion. The metadata set can include, for example, the graphic representation of the e-book 221, such as an iconic representation of a book cover, as well as summary information, author, title, short synapse, language of the e-book, etc.

In one implementation, the processor 210 executes the e-book instructions 251 for implementing the e-book logic 112 to display a selected e-book on the display 230. For example, the processor 210 implements the e-book logic 112 to display, within a display area of the display 230, a portion of content (e.g., a page 231) of the e-book 221. The e-book instructions 251 for implementing the e-book logic 112 can use input provided by a user via user interaction with the input mechanism 240 and/or display 230 (e.g., touchscreen input) to identify the e-book 221 from the memory 250 (e.g., the user selects a graphic corresponding to a cover of the e-book 221 from a bookshelf user interface view) and to display the e-book 221 (e.g., a page 231) on the display 230.

The processor 210 also implements the e-book logic 112 to provide a plurality of features for the user. The user can interact with one or more selectable features or icons to cause the e-reader device 200 to perform additional operations (e.g., operations other than just displaying content), such as note taking, highlighting, searching, looking up a definition, sharing information with other users, etc. For example, the processor 210 implements the e-book logic 112 by executing the e-book instructions 251 to display a portion of content of a content item (e.g., a document or an e-book 221) on the display 230. The processor 210 also executes the e-book instructions 251 to receive user input, such as a user input 243 to perform e-book activities.

In some examples, the processor 210 can execute hand-off instructions 253 for implementing the hand-off logic 114, such as described in an example of FIG. 1. The hand-off logic 114 can be in communication with the e-book logic 112 and can enable a user to request that e-book content be provided to (e.g., handed-off to) another computing device using one of multiple formats. For example, the user of the e-reader device 200 can view a page 231 of e-book content and provide an input on the page 231 to mark a stop position indicating when the user stopped reading the e-book content. The hand-off logic 114 can provide a user interface 233, in which the user can select one of multiple formats to receive a portion of the e-book content for continued consumption. When the user selects a format, such as text message, the hand-off logic 114 can generate a hand-off request 223 that includes, for example, a user identifier, an e-book identifier, a marker position, and information about the selected format. The e-reader device 200 can provide the hand-off request 223 to the network service via the network interface 220.

In another example, the e-book logic 112 can provide a user interface (such a menu) to be displayed on the display 230 in response to user input 243. The menu can include a selectable feature, that when selected by the user, displays the user interface 233 for requesting the hand-off of the e-book content. The user interface 233 can instruct or prompt the user to mark the stop position and select one of multiple formats to receive the subsequent portion of the e-book content.

When the network service receives the hand-off request 223, the network service can determine the user that made the request, the e-book for the user, the stop position in the e-book content, and the format to use to provide subsequent portions of the e-book content. The network service can divide at least a remaining portion of the content subsequent to the stop position into multiple portions (e.g., based on the specified format). The first portion of the multiple portions (e.g., the portion of text that comes after the stop position) can be provided or delivered to the user using the specified format (e.g., via text message, audio file, e-mail), thereby making the e-book content accessible to the user outside of the e-reader device 200 environment.

Device System Description

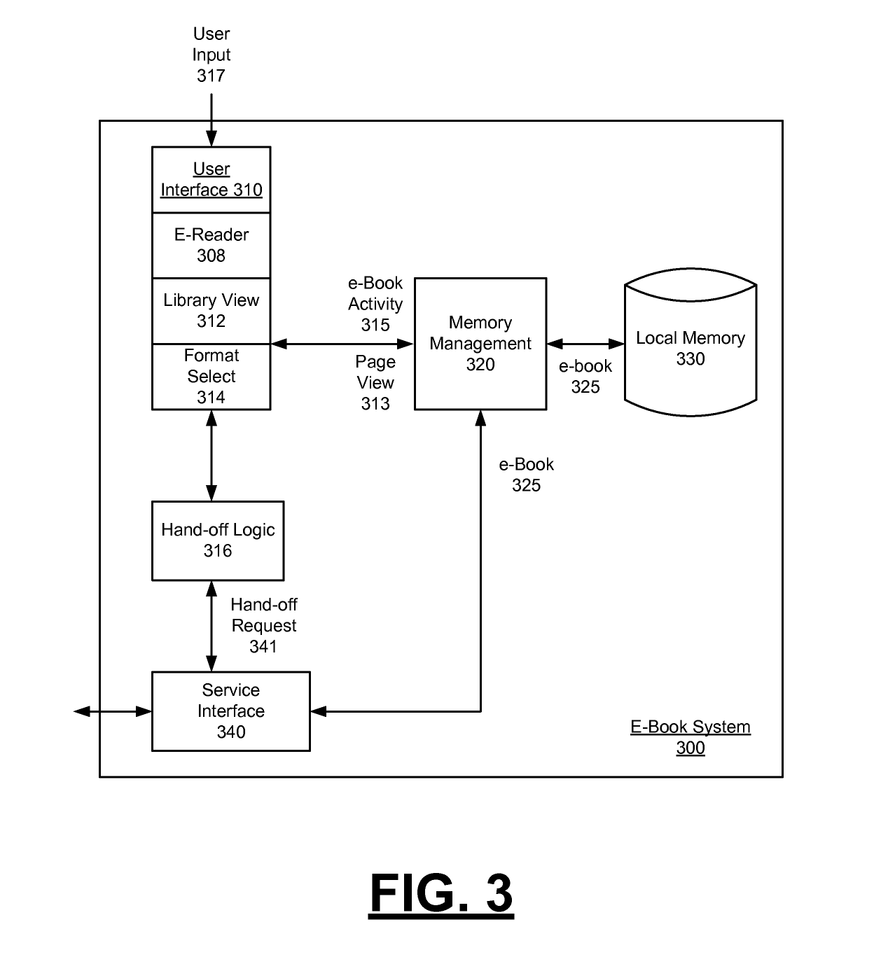

FIG. 3 illustrates an e-book device system for causing portions of the e-book content to be delivered to a user using other formats, according to an embodiment. With reference to FIG. 3, an e-book system 300 implements programmatic components for communicating with an e-book service (such as network service 120, shown in FIG. 1), as well as for enabling functionality for viewing and accessing e-books utilized by an account associated with the e-reader device 110 (see FIG. 1 or FIG. 2). In some embodiments, system 300 can be implemented as an application that runs on an e-reader device, such as shown with examples of FIG. 1 or FIG. 2 (e.g., an e-book or e-reader application).

According to an example of FIG. 3, system 300 includes a user interface 310, hand-off logic module 316, a memory management module 320, a local memory 330, and a service interface 340. Some or all of the programmatic components shown with the computing system 300 can be provided in part as operating system-level components. Alternatively, the programmatic components shown with system 300 can be provided as part of an application that runs on, for example, the e-reader device 110 of FIG. 1 or the e-reader device 200 of FIG. 2. For example, a user can download an application onto the e-reader device 110 to obtain functionality such as described with an example of FIG. 3. Alternatively, the application can be embedded or otherwise pre-installed with other programmatic elements for providing functionality such as described with system 300. Although examples described herein refer to system 300 being implemented on an e-reader device 110 of FIG. 1 or an e-reader device 200 of FIG. 2, in other examples, at least one or more of the programmatic components can be implemented on other devices, such as on another computing device that is in communication with the e-reader device (e.g., a paired or peer-to-peer device), or on one or more computing devices associated with the network service 120.

The service interface 340 includes application logic which enables the e-reader device 110 to use, for example, a wireless network connection (e.g., Internet connection), to connect to the network service 120 (see FIG. 1). In connecting with the network service 120, the service interface 340 can transmit data that enables the network service 120 to identify the e-reader device 110 on which system 300 is implemented (e.g., using a device identifier and/or a user identifier), so that the network service 120 can determine the account that is associated with the particular e-reader device 110. The service interface 340 can be used to retrieve and/or download one or more content items (e.g., e-books 325) from the network service 120 and store the one or more content items in the local memory 330.

For example, in identifying the e-reader device 100 of system 300 to the network service 120, the network service 120 may be able to procure payment information (e.g., stored credit card information) that can be used to charge the user's account when the user purchases a new e-book 325 from the network service 120. Each e-book 325 can correspond to a literary work having a pagination format and a predefined structure. Optionally, some e-books may have chapter designations, as well as content that corresponds to graphics or images (e.g., in the case of magazines, children's books, comic books, etc.). Individual e-books 325 can also include metadata, such as imagery provided as a cover for the e-book 325 when the e-book 325 is marketed (e.g., similar to the manner in which a conventional hardbound book would be marketed in a retail store) or other information, such as publication date, date the e-book was made available, author information, language, etc. In one implementation, the network service 120 can retrieve or otherwise identify the imagery and other metadata of individual e-books from publisher sources.

In addition, in identifying the e-reader device 110 of system 300, the network service 120 can also identify what e-books 325 belong to the account of that device (e.g., have been purchased or downloaded). The e-books 325 that are transmitted to the e-reader device 110 of system 300 include those that are purchased from the e-reader device 110 or those that the user requested to download. In variations, e-books 325 can automatically be downloaded to the e-reader device 110 in response to occurrence of certain conditions. For example, the user can purchase an e-book on another device, and then subsequently connect the e-reader device 110 to the network service 120 to automatically receive their previously purchased e-book. Alternatively, as another example, the network service 120 can be configured to push e-books 325 to the e-reader device 110 of system 300, based on, for example, user account settings, subscription plans and rules, and/or various other business logic considerations.

Additionally, the service interface 340 can include processes for automatically receiving updates from the network service 120. The update(s) can include programmatic updates, including updates to existing programmatic components on the e-reader device 110, as well as updates to lists, e-books 325 that the user may have purchased on another device of the same account, recommendations from the network service 120 as to what a given user may want to purchase or view, and/or various other data that can be either generally provided to the user of the network service 120 or specifically provided for to the particular account or user.

According to some embodiments, the local memory 330 stores each e-book 325 as a record that includes metadata and content (e.g., page content). The memory management module 320 can retrieve portions of individual e-books 325 for purpose of rendering e-books via the user interface 310.

Among other functionality, the user interface 310 can include an e-reader component 308, a library view component 312, and a format select component 314. The e-reader component 308 operates to display content corresponding to, for example, a portion of content of a content item (e.g., a paginated content or page from an e-book 325). The e-reader component 308 can also detect and respond to user inputs 317 made to the e-book 325. The e-reader component 308 can allow user interaction with the displayed page 313 by enabling the user to view other portions of content via user input 317 or by providing prompts or features for enabling the user to enter inputs. In some example, a user input 317 can correspond to an e-book activity 315 that is to be performed on a displayed page 313 of the e-book 325. Examples of an e-book activity 315 can correspond to a page-turning/jumping operation corresponding to transitioning from one page to the next, or from one page by cluster to another, or from one chapter to another, highlighting text on the displayed page 313, generating an annotation on the displayed page 313, displaying a definition of a text item, or zooming in or zooming out of the displayed page 313. Another e-book activity 315 can correspond to a menu operation, such as a selection to display a menu for the e-reader component 308. The memory management module 320 can receive the user inputs 317 and update the displayed page 313 for the e-reader component 308 and/or perform the corresponding e-book activity 315 based on the user inputs 317. For example, the memory management module 320 can provide on the displayed page 313 (to overlay the displayed page 313 or as part of the displayed page 313) a menu with a plurality of different selectable features for performing additional operations.

The library view component 312 can display graphic representations and other information of individual e-books 325 in the user's collection. For example, the library view component 312 can use the metadata associated with the records of the e-books 312 in the user's account to display lists, folders, or other virtual structures that include graphic representations and/or other identifiers of e-books 325 in the user's collection. The user's collection can include e-books 325 that the user has on the particular device (e.g., locally stored e-books 325), as well as e-books 325 that may not be locally stored, but are associated with the user account (e.g., read on another device, archived, etc.).

In one implementation, the local memory 330 can include records for each e-book 325 in the user's account, and each record 326 can include its metadata. The user may have the content portion of select e-books 325 archived, so as not to reside in the local memory 330, but be provided by the network service 120 as requested or needed. By way of example, the library view component 312 can display the e-books 325 of a user's collection using a virtual book shelf or bookcase feature in which the e-books 325 are provided. In such an implementation, the e-books 325 are displayed as icons that include imagery, title information, etc. In a variation, the library view component 312 can display representations of e-books 325 in the user's collection as icons, or as icons with associated text. Still further, folders can be used to provide a panel view of the graphic representations (e.g., icons and/or text) of the e-books 325 in the user's collection.

The format select component 314 can operate to display user interfaces for enabling a user of system 300 to request to view e-book content on another device and/or receive e-book content for consumption using a specified format (other than the e-reader format). A user interface for requesting consumption of e-book content on another device can be displayed, for example, in response to a user input 317 corresponding to a selection of a feature in a menu user interface. The user can interact with the user interfaces provided by the format select component 314 to select a format in which the user would like to receive or view e-book content. In addition, the user can interact with the user interfaces (and/or on the displayed page 313) to provide a marking or a flag on the displayed page 313 indicating a stop position when the user stopped consuming the e-book content on system 300. In other words, the marking or flag can be a bookmarking operation showing the last read or last consumed sentence or text of the e-book content.

Based on the user inputs 317 provided with respect to the user interfaces, the hand-off logic 316 can generate a hand-off request 341 to be provided to the network service 120. The hand-off request 341 can include a user identifier (or device identifier), an identifier for the e-book (e.g. the e-book being displayed) that the user wants to continue consuming on another device, the marked position in the e-book content, and information about the specified format. The hand-off request 341 can be transmitted to the network service 120 via the service interface 340.

System Hardware Description

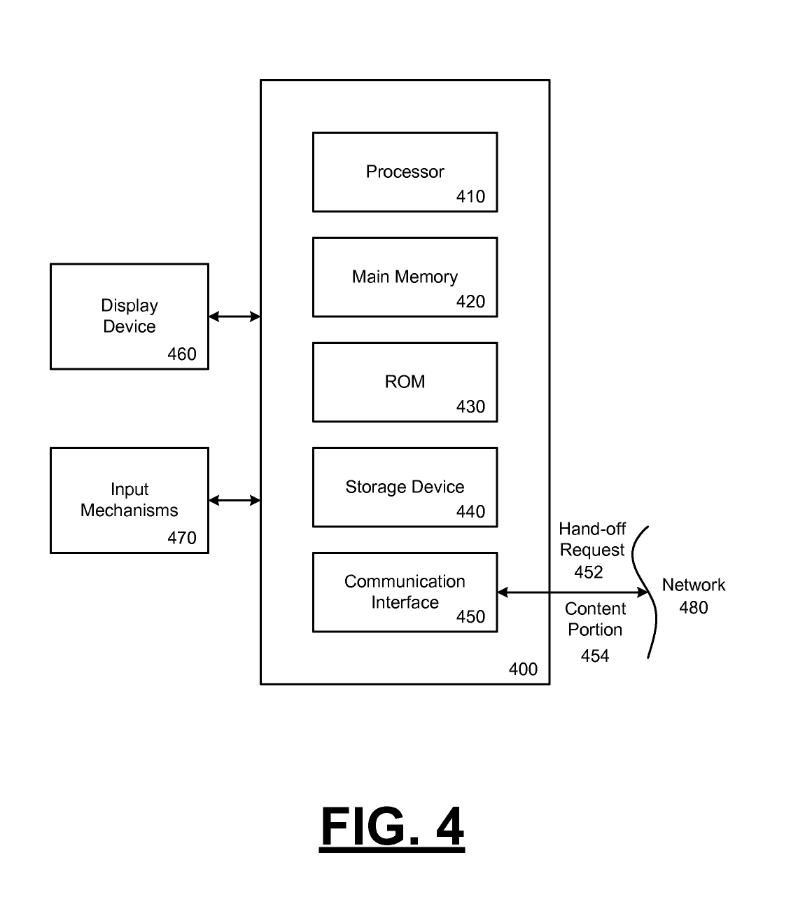

FIG. 4 is a block diagram that illustrates a computer system upon which examples described herein may be implemented. For example, in the context of FIG. 1, the network services 120 may be implemented using a computer system such as described by FIG. 4. The network service 120 may also be implemented using a combination of multiple computer systems as described by FIG. 4.

In one implementation, computer system 400 includes processing resources 410, main memory 420, ROM 430, storage device 440, and a communication interface 450. Computer system 400 includes at least one processor 410 for processing information and a main memory 420, such as a random access memory (RAM) or other dynamic storage device, for storing information and instructions to be executed by the processor 410. Main memory 420 also may be used for storing temporary variables or other intermediate information during execution of instructions to be executed by processor 410. Computer system 400 may also include a read only memory (ROM) 430 or other static storage device for storing static information and instructions for processor 410. A storage device 440, such as a solid-state device, a magnetic disk, or an optical disk, is provided for storing information and instructions. For example, the storage device 440 can correspond to a computer-readable medium that stores instructions for performing operations for the network service discussed with respect to FIGS. 1 through 3. In another example, the storage device 340 can store configuration data and user interface data, such as discussed with respect to FIGS. 1 through 3.

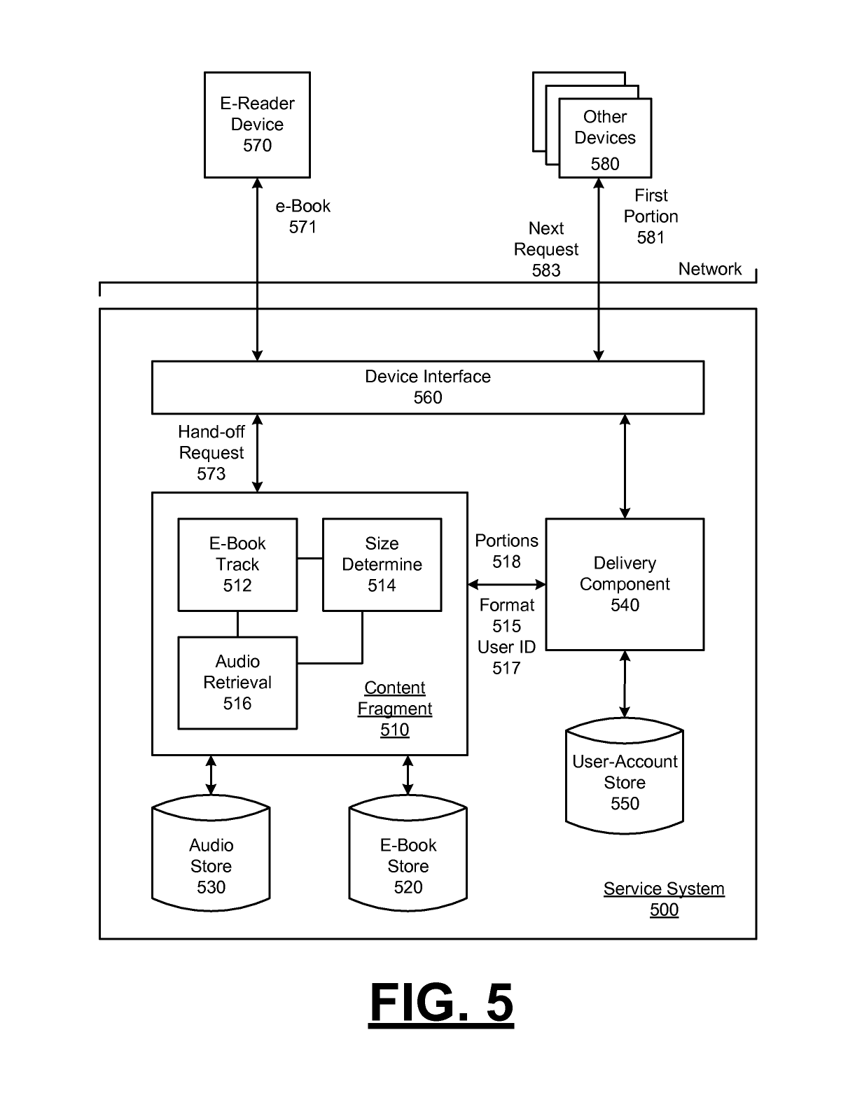

The communication interface 450 can enable computer system 400 to communicate with one or more networks 480 (e.g., cellular network) through use of the network link (wireless and/or using a wire). Using the network link, computer system 400 can communicate with a plurality of devices, such as the e-reader device 110 of FIG. 1 (and other computing devices that may be operated by a user). According to some examples, computer system 400 can receive a hand-off request 452 from the e-reader device 110, respectively via the network link. The processor 410 can execute instructions stored in memory (e.g., main memory 420, ROM 430, the storage device 440, other memory resources, etc.) that, when executed by the processor 410, causes computer system 400 to use information from the hand-off request 452 to determine the user and/or the e-reader device 110 that made the request, determine the e-book content that the user wants to consume, determine the stop position of the e-book content, and the format in which the user requests the e-book content be provided (e.g., text message, audio file, e-mail, etc.). In addition, the processor 410 can execute the instructions to cause computer system 400 to divide at least a remaining portion of the e-book content subsequent to the stop position into multiple portions, and provide, via the communication interface 450 over the network 480, the next content portion 454 for user consumption in the format specified by the user (e.g., as discussed below in FIG. 5).

Computer system 400 can also include a display device 460, such as a cathode ray tube (CRT), an LCD monitor, or a television set, for example, for displaying graphics and information to a user. An input mechanism 470, such as a keyboard that includes alphanumeric keys and other keys, can be coupled to computer system 400 for communicating information and command selections to processor 410. Other non-limiting, illustrative examples of input mechanisms 470 include a mouse, a trackball, touch-sensitive screen, or cursor direction keys for communicating direction information and command selections to processor 410 and for controlling cursor movement on display 460.

Examples described herein are related to the use of computer system 400 for implementing the techniques described herein with respect to the network system. According to one example, those techniques are performed by computer system 400 in response to processor 410 executing one or more sequences of one or more instructions contained in main memory 420, such as instructions discussed above to divide portions of e-book content and deliver portions to the user. Such instructions may be read into main memory 420 from another machine-readable medium, such as the storage device 440. Execution of the sequences of instructions contained in main memory 420 causes processor 410 to perform the process steps described herein. In alternative implementations, hard-wired circuitry may be used in place of or in combination with software instructions to implement examples described herein. Thus, the examples described are not limited to any specific combination of hardware circuitry and software.

Service System Description

FIG. 5 illustrates an example network service system to provide e-book content using one of multiple formats. A network service system of FIG. 5 can correspond to the network service 120 of FIG. 1. According to an example, system 100 includes a content fragment component 510, an e-book store 520, an audio store 530, a delivery component 540, a user account store 550, and a device interface 560. System 100 can communicate with one or more e-reader devices, such as e-reader device 570, and other computing devices 580 over one or more networks. The components of system 100 can combine to receive a request from an e-reader device to provide portions of e-book content using one of multiple formats to a user. Logic can be implemented with various applications (e.g., software) and/or with hardware of a computer system that implements system 100.

Depending on implementation, one or more components of system 100 can be implemented on network side resources, such as on one or more servers. System 100 can also be implemented through other computer systems in alternative architectures (e.g., peer-to-peer networks, etc.). As an addition or an alternative, some or all of the components of system 100 can be implemented on client devices, such as through applications that operate on the e-reader device 570 and/or other computing devices 580. System 100 can communicate over one or more networks, via a network interface (e.g., wirelessly or using a wireline), to communicate with the e-reader device 570 and other computing devices 580.

System 100 can communicate, over one or more networks, with the e-reader device 570 and other computing devices 580 using a device interface 560. The device interface 560 can manage communications between system 100 and the e-reader device 570, and also enable system 100 to exchange communications with other computing devices 580. In one example, the e-reader device 570 can operate an e-reader application (or operating system) that can interface with the device interface 560 to communicate with system 100.

According to an example, a user can operate an e-reader device 570 to consume (e.g., read or view) content of an e-book 571. As discussed, in some examples, the e-book 571 can be downloaded to a memory of the e-reader device 570. The e-reader device 570 can include an e-reader application that enables the e-reader device 570 to display, for example, in paginated view, portions of content of the e-book 571. When the user decides to stop reading or consuming the e-book 571, the user can typically close the e-reader application or place the e-reader device 570 in a power-saving state (e.g., lock the device, turn off the display). In one example, however, the user can stop consuming the e-book 571 on the e-reader device 570, but can continue to read portions of the content of the e-book 571 on other devices and/or in other formats outside of the e-reader device 570 environment.

For example, the user can provide input via the e-reader device 570 to generate a hand-off request 573, such as discussed above with respect to FIGS. 1 through 3, to be provided to system 500 over one or more networks. The user can provide (i) input on a displayed page of the e-book 571 to mark or flag a stop position in the content of the e-book, which indicates where in the content the user stopped consuming the content on the e-reader device 570, and (ii) input to select a specified format to continue consuming the e-book 571. The hand-off logic implemented by the e-reader device 570 can detect the mark in the page to identify a position in the content of the e-book and provide information about the position in the hand-off request 573. In addition, the hand-off logic can provide information about the selected format in the hand-off request 573.

In general, the hand-off request 573 can indicate to system 500 that the user, who is reading the e-book 571, would like to continue to consume the e-book 571 on another device or in another format. The hand-off request 573 can include a user identifier of the user (and/or a device identifier of the e-reader device 570), an identifier of the e-book 571, information about the stop position, and/or a specified format in which the user would like to consume portions of the e-book 571.

The content fragment component 510 can receive the hand-off request 573 via the device interface 560. In response, the content fragment component 510 can determine (at least) a remaining portion of the e-book content (assumed to not yet be consumed by the user) and divide or fragment the remaining portion into multiple portions. For example, the user may have reached the end of a paragraph in chapter five of the e-book 571 and provided an input to mark the stop position. There may be twenty additional paragraphs left in chapter five (or seven thousand characters of text remaining) and thirty chapters in the e-book 571. The content fragment component 510 can divide a remaining portion of the e-book content subsequent to the stop position, such as the rest of chapter five, the rest of chapter five and the next three chapters, or all of the remaining portion of the e-book content, etc., into multiple portions.

According to an example, an e-book track component 512 of the content fragment component 510 can extract or determine the information about the stop position from the hand-off request 573 to determine where, in the content of the e-book, the user has stopped consuming the e-book 571. In one example, the e-book track component 512 can use the e-book identifier to access the e-book store 520 and retrieve the e-book 571 corresponding to the e-book identifier. Using the information about the stop position and the content from the e-book 571, the e-book track component 512 can identify, in the content, where the user stopped consuming the content on the e-reader device 570, and similarly, what portions of the content of the e-book 571 the user has not consumed. Referring back to the example above, the e-book track component 512 can determine that the user stopped reading on paragraph seventy of chapter five, and/or that twenty chapters are left in chapter five as well as thirty more chapters.

In addition, in some examples, a size determine component 514 of the content fragment 510 can extract or determine a specified format requested by the user for further consumption of the e-book 571 from the hand-off request 573. Depending on implementation, the specified format can correspond to a text message, an e-mail, an audio file, or other formats. Based on the specified format, the size determine component 514 can determine how to size a portion (of multiple portions of the remaining content) of the e-book 571 to properly deliver the portion of the content to the user. For example, an SMS text message is typically limited to 160 characters. If the specified format corresponds to an SMS text message, the size determine component 514 can instruct the content fragment component 510 that the size of a set of remaining portions of e-book content is to be limited to 160 characters. The content fragment component 510 can divide a portion of the e-book content subsequent to the stop position into multiple portions, where the next portion after the stop position (as well as one or more subsequent portions) is sized to include 160 characters.

Referring back to the example, the content fragment component 510 can divide, for example, the first ten of the twenty remaining paragraphs of chapter five into multiple portions, with each of the multiple portions having a maximum of 160 characters each. At a later time, if the content fragment component 510 determines that those then ten paragraphs have been consumed by the user, additional paragraphs can be divided into multiple portions for further consumption.

As another example, if the specified format corresponds to an e-mail, for example, the size determine component 514 can be instructed (e.g., configured with predetermined size information) to size the portions to include one or two paragraphs of text of the e-book content. A body of an e-mail can contain much more text and content than an SMS message. As such, a portion of content subsequent to the stop position can be divided into multiple portions, with each portion being sized to have more than 160 characters (e.g., can have one, two, three, five, etc., paragraphs of content). In other examples, the size determine component 514 can reference a database that provides a mapping between formats and portion sizes (e.g., either a number of characters and/or a number of sentences or paragraphs).

In some examples, the user can specify that she would like to continue to consume the e-book 571 by listening to an audio file. As a result of the user's selection input, the hand-off request 573 can indicate that the requested format is an audio file. The content fragment component 510 can determine, from the hand-off request, that at least a remaining portion of e-book 571 content is to be provided to the user via audio. Depending on implementation, an audio retrieval component 516 of the content fragment component 510 can first access the audio store 530 using the identifier of the e-book 571 to determine if corresponding audio exists (e.g., as an audio-book) for that e-book 571. If the e-book 571 has a corresponding audio file stored in the audio store 530, the audio retrieval component 516 can retrieve the corresponding audio file, and perform a search within the audio file for a time corresponding to the stop position in the e-book 571 content. For example, if the audio book is twenty hours in length, the stop position in the e-book 571 content can correspond to a time, such as four hours, fifteen minutes, and three seconds (e.g., corresponding to a marking after a paragraph of chapter five, in the example discussed above).

From this time forward, the content fragment component 510 can divide a remaining portion of the e-book 571 content (e.g., a portion of the e-book audio file) subsequent from the determined stop time into multiple audio portions or audio files. The size (such as the size in KBs or MBs, or in size of length of time) of individual audio portions can be based on a size of the audio file specified by the size determine component 514. For example, as discussed, the size determine component 514 can determine the specified format and the minimum size and/or maximum size a portion of e-book 571 content can be (e.g., using a mapping or association database). In this example, the content fragment component 510 can determine a next twenty minutes of the e-book 571 content as an audio file subsequent to the stop time, and divide this audio portion into multiple audio portions satisfying the size specification.

In some examples, an e-book 571 may not have a corresponding audio book stored in the audio store 530. Depending on implementation, the audio retrieval component 516 can determine that no match was found and dynamically create an audio file corresponding to a portion of content subsequent to the stop position by converting the text in that portion to speech. For example, the audio retrieval component 516 can include or be in communication with a text-to-speech conversion module (not shown in FIG. 5) that can convert text from a portion of the e-book 571 content into an audio file. The content fragment component 510 can then divide that audio file into multiple audio portions, such as discussed above.

In another example, if no corresponding audio book for the e-book 571 is found in the audio store 530, the audio retrieval component 516 can indicate to the content fragment component 510 that no match was found. The content fragment component 510 can provide a notification to the e-reader device 570 and/or to the user's e-mail address or smartphone (e.g., via SMS text message or phone call) notifying the user that audio for the e-book 571 cannot be provided to the user and prompting the user to make another format selection. As an addition or an alternative, if the audio retrieval component 516 determines that no audio book exists for the e-book 571, the content fragment component 510 can determine a default format such as text message or e-mail, and perform the operations discussed above with respect to text message or e-mail.

After the content fragment component 510 divides a portion of e-book content 571 into multiple portions based on the selected format, one or more portions 518 of the multiple portions are provided to the delivery component 540. In some examples, the content fragment component 510 can also provide the specified format 515 and the user identifier 517 to the delivery component 540 along with the one or more portions 518. The delivery component 540 can use the received user identifier 517 to access the user account store 550 and identify the user's profile or account with the service system 500. As discussed, the user account store 550 can store a plurality of profiles or accounts associated with a plurality of users, with each account including a user identifier, an email address, a cell phone number, other device information (e.g., identifiers of the user's other devices 580), a billing address, payment information, and/or other user-specific information.

Depending on the format 515 specified by the user, the delivery component 540 can provide a first portion 581 of the multiple portions (e.g., the portion coming just after the stop position) to the user. For example, if the format 515 is for an SMS message, the delivery component 540 can package the first portion 581 as a text message and send it to the user's cell phone number. In this example, the first portion 581 can be transmitted with or as part of a text message that is sent to the user's smartphone 580 (the device associated with the cell phone number) (e.g., via one or more networks, including a cellular network). In this case, the user's smartphone 580 is a device that is different from the e-reader device 570. As an addition or an alternative, the first portion 581 can correspond to multiple portions 518 of text message (e.g., ten text messages provided serially according to the SMS text message format) so that the user can view a larger portion of the e-book 571 content on the user's device 580. Ten text messages provided serially as the first portion 581 can include at least 1600 characters as opposed to just transmitting one text message of 160 characters.

As another example, if the format 515 is for an e-mail, the delivery component 540 can package the first portion 581 as an e-mail, where the text content of the first portion 581 can be included in the body of the e-mail. The delivery component 540 can address the e-mail to the user's e-mail address and in some examples, can include a heading in the subject field of the e-mail, indicating a name of the e-book 571 and/or information indicating that the e-mail corresponds to a portion of e-book 571 content. In this example, the first portion 581 can be transmitted with or as part of the e-mail to, via one or more networks, the user's e-mail account. The user can open the e-mail by accessing the user's e-mail account on any of the user's other devices 580 (including the user's e-reader device 570 if the e-reader device 570 includes an email application or a browser to enable the user to access the e-mail account).

If the format 515 is an audio format, the delivery component 540 can receive a first portion 581 of the audio portions as an audio file (e.g., MP3) from the content fragment component 510. The delivery component 540 can provide the first portion 581 by attaching it to a message, such as an e-mail message addressed to the user's e-mail address, or by providing it as part of an in-application audio file that can be consumed using an application on another device 580 of the user. For example, the user can operate one of multiple media applications, such as a music application or e-book reader application, on another device 580, such as on the user's smartphone. The audio file of the first portion 581 can be transmitted over one or more networks via the device interface 560 to the user's smartphone, so that the user can consume the first portion 581 using a media application.

As an addition or an alternative, the user may request system 500 to output the e-book as audio using the e-reader device 570. For example, the user may be tired of reading on the e-reader device 570 and can select the audio format and request the audio be transmitted via the e-reader application of the e-reader device 570. The delivery component 540 can provide the audio file to the e-reader device 570 (as opposed to another device 580) for consumption by the user on the e-reader device 570.

Regardless of the format type, the user can consume the first portion 581 on a computing device that is outside of the e-reader application environment of the e-reader device 570. The user can read or listen to the first portion of the e-book 571 content from where they last read the e-book 571 on the e-reader device 570. Depending on implementation, system 500 can assume that the user has not actually read or consumed the provided first portion 581 unless indicated by the user that the first portion 581 has been consumed. The e-book track 512 can maintain the stop position information in the e-book 571 content and/or update the stop position if system 500 receives indication that a portion has been consumed. In one example, the user can provide a response using the format in which the first portion 581 was received, indicating that the first portion 581 has been consumed.

In addition, from the user's other computing device 580, for example, the user can make a request 583 for a next portion of the e-book 571 content to system 500 to continue reading or consuming the e-book 571. A request 583 for the next portion can be indicative of the user having consumed the first portion 581. If such a response (e.g., an indication response that the last portion has been consumed and/or a request for additional content) is received by the content fragment component 510 and/or the delivery component 540, the e-book track component 512 can update the new stop position to a position after the first portion 581.

For example, if the first portion 581 was received as a text message, the user can respond or provide a reply text message 583 back to the sender identifier or phone number (e.g., one that is associated with system 500). The reply can be a blank text message with no content in the body, or a message with any text or specified text, such as “keep reading.” When the device interface 560 receives the reply text message from the user's smartphone 580, for example, the reply text message can be an indication that the next portion of e-book 571 content is to be provided to the user again. In one example, the delivery component 540 can receive the reply text message and/or an indication that the next portion is requested, and can transmit the next portion to the user's device 580 in the similar format as previously transmitted.

As another example, the next request message 583 can be an e-mail transmitted to system 100 to reply to the e-mail previously received with the first portion 581 in a similar fashion. The previous e-mail may have included the first portion 581 as text in the body of the e-mail or as an audio file attachment. The delivery component 540 can receive the reply e-mail and transmit the next portion, via e-mail, to the user's e-mail account. According to some examples, the delivery component 540 can also ping or request the content fragment component 510 for the next portion of e-book 571 content if the delivery component 540 has not yet received the next portion.

As an addition or an alternative, the user can operate the device 580 and transmit a next request message 583 with some instruction or additional request to transmit the next portion using a different format. For example, the reply text message or e-mail can specify, in the body, a predefined instruction, e.g., “keep reading as text” or “keep reading as audio” or “keep reading as e-mail.” When the delivery component 540 receives the reply text message or e-mail, the delivery component 540 can determine the request from the body of the message and communicate with the content fragment component 510 to change, if necessary, the format. The content fragment component 510 can divide the next portions of e-book 571 content into multiple portions according to the most recently requested format.

In another example, if the user receives the first portion 581 as an audio file for consumption using a media application or an e-reader application on the user's device 580, the user can provide an indication and/or a response via the media application or the e-reader application. Such applications can enable communications (via application program interfaces, for example) with system 500 over the device interface 560.

Based on where or when the user last consumed the e-book 571 using any one of multiple formats, the e-book track component 512 can update the stop position to indicate where or when the user stopped consuming the e-book 571. For example, using any of the multiple formats, the user may have continued to consume the e-book 571 from the end of a paragraph of chapter five (e.g., the previous stop position) to the first paragraph of chapter six. The e-book track component 512 can update the stop position to the end of the first paragraph of chapter six based on receiving indication from the user that the user has consumed the e-book 571 up to that point.

When the user operates the e-reader device 570 at a later time to continue reading the e-book 571, the e-book track component 512 can provide information about the updated stop position to the e-reader application running on the e-reader device 570. In this manner, when the user opens or launches the e-reader application or opens the particular e-book 571, the e-reader application can open the e-book 571 to the specific page where the user left off (e.g., display the page of the e-book 571 content after the end of the first paragraph of chapter six). The user can continue to consume the e-book 571 from the last read or last listened-to sentence or text of the e-book 571.

Such a system can encourage the user to consume content within and outside of the e-reader application environment. The user is able to continue reading even when she may not have a large block of time for reading, as portions of the e-book being read by the user is provided in smaller segments using different formats for efficient consumption. In addition, portions of content can be serially delivered to the user using any of the user's devices so that reading is not limited to just the e-reader device 570.

Methodology

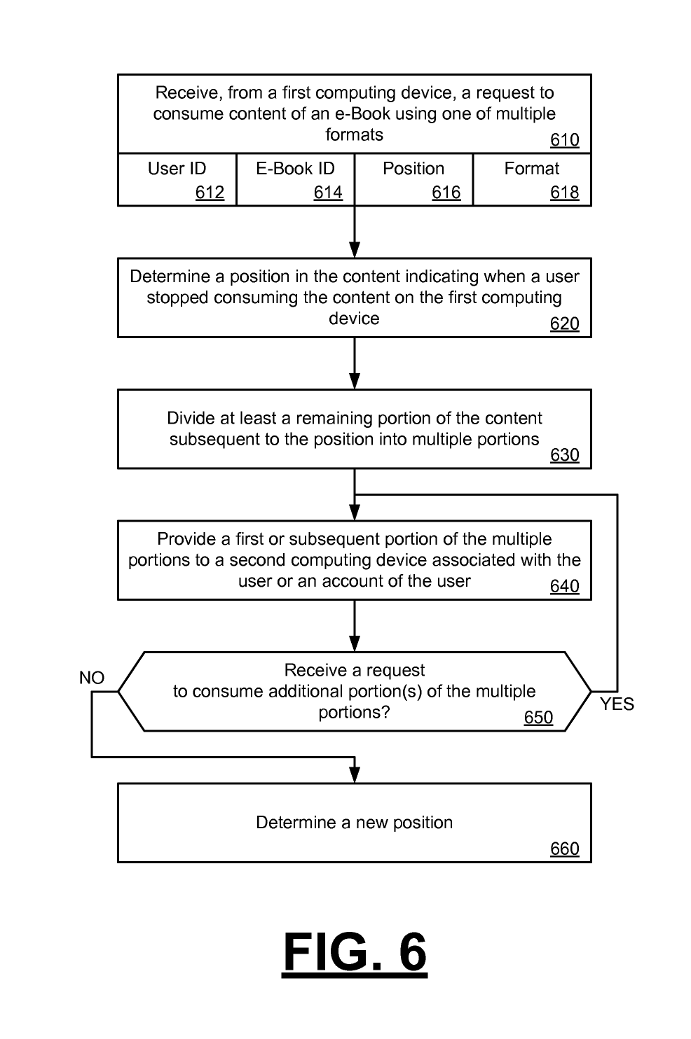

FIG. 6 illustrates an example computer-implemented method for providing e-book content using one of multiple formats, according to at least some embodiments. A method such as described by an example of FIG. 6 may be implemented using components such as described with an example of FIGS. 1 through 5. Accordingly, reference may be made to elements of other figures for purpose of illustrating an example of a suitable component for performing a step or sub stepping described.

With reference to FIG. 6, a server (e.g., one or more computing devices) that implements the network service system 120 of FIG. 1 or system 500 of FIG. 5, for example, can receive, from a first computing device of a user, a request to consume content of an e-book using one of multiple different formats (610). The request can be transmitted from the first computing device, which can be in communication with the server over one or more networks. Such a first computing device can correspond to an e-reader device, such as the e-reader device 110 of FIG. 1, or another computing device of the user that runs an e-reader application for displaying content of an e-book.

In some examples, the request can include information about the user, such as a user identifier (612) or a device identifier, an e-book identifier (614), information about a position (616) indicating when the user stopped consuming the content (e.g., a stop position), and/or a specified format (618). For example, the user, when operating an e-reader application on the first computing device, can view a page of content of the e-book, and can indicate on the page, via user input, a marking or flag in the content indicating where she has stopped reading. The user can also select a format option, from a menu user interface, indicating that the user wants to continue to read the e-book on another device or using a different format outside of the e-reader application environment. The e-reader application can generate the request and provide the request to the server.

In another example, when the request is generated by the e-reader application (or e-book system 300 of FIG. 3), the request can automatically indicate that the stop position is at the end of the first sentence displayed on the top of the displayed page of the e-reader device (e.g., without the user specifying a separate marking on the page). This can ensure that the stop position is not provided after a section of the page that the user has not yet read.

The server can receive the request and determine that the user wishes to continue to consume the e-book using the specified format. In addition, the server can determine a position in the content indicating where the user stopped consuming the e-book content on the first computing device (620). For example, the server can extract the stop position information from the request and determine where, in the content of the e-book, the marking or flag is located. As an addition or an alternative, the server can determine the position indicating where the user stopped consuming the e-book on the first computing device before receiving the request from the e-reader device. For example, whenever the user provides a marking on the page of the content on the e-reader device, as a stop position (so that the user knows where to start reading from the next time she reads the e-book on the device), the server can receive an indication of the stop position from the e-reader device. In such an example, the server can receive information about the stop position before receiving the request from the e-reader device.

The server can determine (at least) a remaining portion of the content of the e-book subsequent to the stop position, and divide the remaining portion (such as the next set of paragraphs after the stop position) into multiple portions based on the specified format (630). In one example, the size of the portions (e.g., the amount of text, the number of characters, the number of paragraphs, etc.) can be based on the type of format specified by the user (e.g., text message, e-mail, audio file, etc.).

The server can provide a first portion of the multiple portions to a second computing device (e.g., using a phone number associated with that device) or to an account associated with the user (e.g., the user's instant messaging account or the user's e-mail account) using the selected format of multiple formats (640). For example, the first portion can be the next portion of content of the e-book after the stop position for the user to consume. As an example, the user can indicate a marking for a stop position in between two words of a sentence, such as the fifth and sixth words of the sentence. The first portion can begin from the sixth word of the sentence.

The server can determine if it has received a request to consume and additional portion of the e-book content (650). If the server receives a request message from a user device (and/or an account associated with the user), the server can update the stop position to the position in the content subsequent to the last sent portion and then provide the subsequent portion of the multiple portions of the e-book content (e.g., a second portion after the first portion previously sent) to the user in the same format as the previously sent format (or in some examples, in a different format if requested by the user). The server can continue to provide additional subsequent portions in serial in response to user requests, until no request is received. On the other hand, if the server does not receive a request to consume additional portions or does not receive indication that the last sent portion has been read, the server will not transmit another portion and can determine the new stop position for the user (if any) (660). For example, if the server did not receive a message indicating that the previous transmitted portion has been consumed, the server can be instructed to conclude that the transmitted portion has not been consumed by the user and set the new stop position as the previous stop position before the content of the transmitted portion. In this manner, the server is able to provide the last bookmark to revert to the pre-text message or pre-e-mail state so that the user can get an accurate bookmark of her actual last-consumed location on the e-book content when the user opens the e-reader application again on her e-reader device.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is being claimed is:

1. A method of providing e-book content, the method being performed by one or more processors and comprising:
determining a position in a content of an e-book, the position indicating when a user stopped consuming the content on a first computing device associated with the user;
dividing at least a remaining portion of the content subsequent to the position into multiple portions; and
providing, over one or more networks, a first portion of the multiple portions to a second computing device associated with the user using one of multiple formats.

2. The method of claim 1, wherein determining the position includes detecting a marking inputted by the user when operating the first computing device.

3. The method of claim 1, further comprising:
receiving, from the first computing device, a request to consume the content starting from the position using a specified format of the multiple formats.

4. The method of claim 3, wherein determining the position is performed in response to receiving the request.

5. The method of claim 4, wherein dividing at least the remaining portion of the content includes determining a size of individual multiple portions based on the specified format.

6. The method of claim 1, wherein the multiple formats include at least one of a text message, an audio file, or an e-mail message.

7. The method of claim 1, wherein dividing at least the remaining portion of the content includes generating, for each of the multiple portions, an audio file corresponding to text content of that portion.

8. The method of claim 1, further comprising:
receiving, from the second computing device, a request to consume a second portion of the multiple portions subsequent to the first portion; and
providing, over the one or more networks, the second portion of the multiple portions to the second computing device using one of multiple formats.

9. The method of claim 8, wherein the first portion is provided using a first format of the multiple formats, and wherein the second portion is provided using a second format of the multiple formats, the second format being different than the first format.

10. A non-transitory computer-readable medium storing instructions that, when executed by one or more processors of a computing device, cause the computing device to:
determine a position in a content of an e-book, the position indicating when a user stopped consuming the content on a first computing device associated with the user;
divide at least a remaining portion of the content subsequent to the position into multiple portions; and
provide, over one or more networks, a first portion of the multiple portions to a second computing device associated with the user using one of multiple formats.

11. The non-transitory computer-readable medium of claim 10, wherein the instructions cause the computing device to determine the position by detecting a marking inputted by the user when operating the first computing device.

12. The non-transitory computer-readable medium of claim 10, wherein the instructions further cause the computing device to:
receive, from the first computing device, a request to consume the content starting from the position using a specified format of the multiple formats.

13. The non-transitory computer-readable medium of claim 12, wherein the instructions cause the computing device to determine the position in response to receiving the request.

14. The non-transitory computer-readable medium of claim 13, wherein dividing at least the remaining portion of the content includes determining a size of individual multiple portions based on the specified format.

15. The non-transitory computer-readable medium of claim 10, wherein the multiple formats include at least one of a text message, an audio file, or an e-mail message.

16. The non-transitory computer-readable medium of claim 10, wherein the instructions cause the computing device to divide at least the remaining portion of the content by generating, for each of the multiple portions, an audio file corresponding to text content of that portion.

17. The non-transitory computer-readable medium of claim 10, wherein the instructions further cause the computing device to:
receive, from the second computing device, a request to consume a second portion of the multiple portions subsequent to the first portion; and
provide, over the one or more networks, the second portion of the multiple portions to the second computing device using one of multiple formats.

18. The non-transitory computer-readable medium of claim 17, wherein the first portion is provided using a first format of the multiple formats, and wherein the second portion is provided using a second format of the multiple formats, the second format being different than the first format.

19. A computing device, comprising:
a communication interface;
a memory storing instructions; and
a processor, coupled to the communication interface and the memory, to execute the instructions, wherein the instructions, when executed by the processor, causes the computing device to:
determine a position in a content of an e-book, the position indicating when a user stopped consuming the content on a first computing device associated with the user;
divide at least a remaining portion of the content subsequent to the position into multiple portions; and
provide, over one or more networks, a first portion of the multiple portions to a second computing device associated with the user using one of multiple formats.

20. The computing device of claim 19, wherein the instructions further cause the computing device to:
receive, from the first computing device, a request to consume the content starting from the position using a specified format of the multiple formats; and
wherein the instructions cause the computing device to determine the position in response to receiving the request.
